(19) United States
(12) Patent Application Publication
(10) Pub. No.: US 2026/0082350 A1
(43) Pub. Date: Mar. 19, 2026

(54) METHODS AND SYSTEMS FOR NETWORK REPOSITORY FUNCTION (NRF) STATUS NOTIFICATION

(71) Applicant: T-Mobile USA, Inc., Bellevue, WA (US)

(72) Inventors: Narayanan Govindan Kasi, Olathe, KS (US); Saravana Velusamy, Overland Park, KS (US)

(21) Appl. No.: 18/889,112

(22) Filed: Sep. 18, 2024

(51) Int. Cl. H04W 60/04; H04L 41/0604; H04W 8/18; H04W 24/08

(52) U.S. Cl. CPC H04W 60/04; H04L 41/0613; H04W 8/18; H04W 24/08

(57) ABSTRACT

Methods and systems for notifying a network function (NF) regarding the status change of a network repository function (NRF) are disclosed. According to an implementation, the NRF may receive via a network and from an NF, a request to create a subscription to an event of the NRF. In the subscription data, the NF may identify the NRF of which, the status is requested to be monitored. The NF may also indicate one or more types of events on the NRF that are requested to be notified. The NRF may create, in a data storage, the subscription and assign a subscription ID to the subscription. The NRF may send a response to the request along with the subscription ID. Upon detecting an occurrence of the event that the NF subscribes to, the NRF may send a notification to the NF based on the subscription associated with the subscription ID.

The Network Repository Function (NRF) is a critical component in the Fifth Generation (5G) core network as defined by the Third Generation Partnership Project (3GPP). In the 5G core network, various network functions (NFs) are interconnected. These NFs require a centralized registry to discover and communicate with each other. As the 5G core network evolves to provide more services and flexibility than its predecessors, its architecture requires efficient service management and discovery. The NRF acting as a central registry, is interconnected with almost every NF instance in the 5G core network such as access and mobility management function (AMF), session management function (SMF), user plane function (UPF), etc. The NRF allows an NF instance to register its service and discover the services provided by other registered NF instances.

An NF instance (i.e., NF consumer) that uses the service provided by another NF instance (i.e., NF producer) may subscribe to the events associated with the NF producer so that the NF consumer can obtain the up-to-date status of the NF producer. The subscription is created by the NRF and stored in a data storage of the NRF. When the NRF receives an update request triggered by an event associated with the NF producer, the NRF notifies the NF consumer regarding the event. However, the NRF currently has no way to notify the NF instances about its own status change or the changes in the registration on an ad-hoc basis.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates an example network scenario, in which, methods of notifying network functions regarding the status change in a network repository function is implemented according to an example of the present disclosure.

FIG. 2 illustrates an example scenario, in which, the NRF status notification is implemented according to an example of the present disclosure.

FIG. 3 illustrates an example scenario, in which, the NRF status notification is implemented according to another example of the present disclosure.

FIG. 4 illustrates an example process for notifying an NF regarding the status change of an NRF according to an example of the present disclosure.

FIG. 5 illustrates an example computing device, in which methods for NRF status notification are implemented according to an example of the present disclosure.

### DETAILED DESCRIPTION

Techniques for a network repository function (NRF) to notify a network function (NF) regarding a status change or a change in NF registration information in are disclosed herein. In some implementations, a method for notifying an NF regarding a status change in an NRF may be implemented by an NRF in a wireless communication network.

The network repository function (NRF) may include a processor and a non-transitory computer-readable memory storing computer-executable instructions that, when executed by the processor, cause the processor to receive, via a network and from a network function (NF), a request to create a subscription to an event of the NRF. In the subscription data, the NF may identify the NRF, of which, the status change is requested to be monitored. In some examples, the NF may set an attribute of the subscription data, e.g., “subscrCond” as the NRF to be monitored. In some examples, in the subscription data, the NF may further identify a validity time, after which, the subscription is invalid. In yet other examples, in the subscription data, the NF may indicate to receive all event notifications from the NRF. In yet another example, in the subscription data, the NF may indicate to receive one or more event notifications from the NRF.

Upon receiving the request, the NRF may create, in a data storage, the subscription for the NF. The subscription is assigned with a subscription ID. The NRF may send a response to the NF to indicate a completion or success of the subscription. The NRF may further forward the subscription ID to the NF.

In implementations, the NRF may detect an occurrence of the event. If the event is subscribed by an NF, the NRF may send, via the network, a notification based on the detected event to the NF. In some examples, the event indicates a registration of the NF is expired or the registration of the NF is lost and the notification may include a request for the NF to re-register. In another example, the event indicates a change of heartbeat timer pre-set for the NF and the notification may indicate a new heartbeat timer set for the NF. In yet another example, the event indicates a change of an availability time of the NRF and the notification includes a new availability time of the NRF. In yet another example, the event indicates the subscription is expired or the subscription is expiring after a time period and the notification includes a request for the NF to re-subscribe.

The present disclosure allows a network function to subscribe to the NRF to receive the status change of the NRF. By subscribing to the NRF events, the network function in the network can be promptly notified about any changes of the NRF and/or any registration/subscription information change, and therefore, facilitating the status sharing and avoiding unnecessary re-registration or re-subscription attempts from the network function.

The techniques discussed herein may be implemented in a computer network using one or more of protocols including but are not limited to Ethernet, 3G, 4G, 4G LTE, 5G, Sixth Generation (6G), the further radio access technologies, or any combination thereof wherever carrier aggregation concepts and principles apply. Example implementations are provided below with reference to the following figures.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

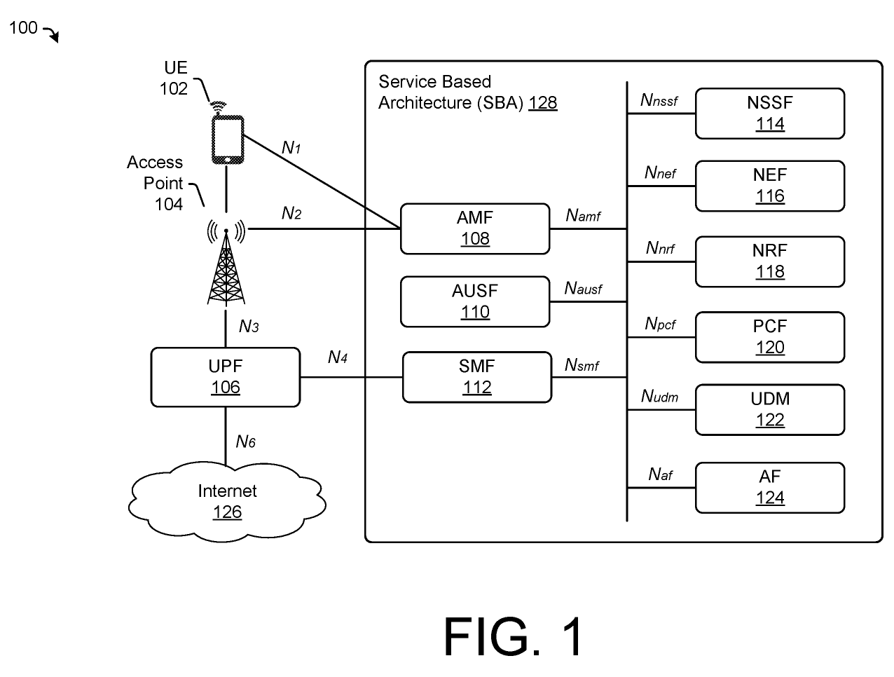

FIG. 1 illustrates an example network scenario, in which, methods of notifying network functions regarding the status change in a network repository function is implemented according to an example of the present disclosure.

The network scenario 100, as illustrated in FIG. 1, may be associated with a telecommunication network of a wireless service provider. A user equipment (UE) 102 may attach to a public land mobile network (PLMN) of the wireless service provider through an access point 104. The UE 102 may be any device that can wirelessly connect to a telecommunication network. The UE may support various radio access technologies such as Bluetooth, Wi-Fi, GSM, CDMA, WCDMA, UMTS, 4G/LTE or 5G NR. In some examples, the UE 102 may be a mobile phone, such as a smart phone or other cellular phone. In other examples, the UE 102 may be a personal digital assistant (PDA), a media player, a tablet computer, a gaming device, or any other type of computing or communication device. In yet other examples, the UE 102 may include the computing devices implemented on the vehicle including but are not limited to, an autonomous vehicle, a self-driving vehicle, or a traditional vehicle capable of connecting to internet. In yet other examples, the UE 102 may be a wearable device and/or wearable materials, such as a smart watch, smart glasses, clothes made of smart fabric, etc. In further examples, the UE 102 may be a virtual reality or augmented reality goggles or glasses.

In implementations, the access point 104 may be compatible with one or more radio access technologies, protocols, and/or standards, such as 5G New Radio (NR) technology, LTE/LTE Advanced technology, other fourth generation (4G) technology, High-Speed Data Packet Access (HSDPA)/Evolved High-Speed Packet Access (HSPA+) technology, Universal Mobile Telecommunication System (UMTS) technology, Code Division Multiple Access (CDMA) technology, Global System for Mobile Communications (GSM) technology, WiMAX technology, Wi-Fi technology, and/or any other previous or future generation of radio access technology. For example, the access point 104 may be a gNB associated with a 5G radio access network (RAN) or an eNB associated with a 4G/LTE RAN. Although not shown, the access point 104 may also be associated with a second generation (2G) base station, a third generation (3G) NodeBs associated with GSM and CDMA access network, digital subscriber line (DSL) and variations of DSL technology that provide access to desktops, workstations, and/or mainframes, Wi-Fi connections to the user equipment, etc. The core network may be referred to as a backbone network of the telecommunication network, such as, a 5G core network, an evolved packet core (EPC) network, etc.

The PLMN of the wireless service provider may include a variety of network functions including but is not limited to, an access and mobility management function (AMF) 108, an authentication server function (AUSF) 110, a session management function (SMF) 112, a network slice selection function (NSSF) 114, a network exposure function (NEF) 116, a network repository function (NRF) 118, a policy control function (PCF) 120, a unified data management function (UDM) 122, an application function (AF) 124, a user plane function (UPF) 126, etc. In some examples, the AMF 108, the AUSF 110, the SMF 112, the NSSF 114, the NEF 116, the NRF 118, the PCF 120, the UDM 122, and the AF 124 may form a service based architecture (SBA) 128 in the home PLMN.

The AMF 108 may be configured to manage the access and mobility of the mobile devices (e.g., UE 102). When a mobile device attaches to the PLMN through an access network (e.g., access point 104), the AMF 108 may send an authentication request to the AUSF 110 to perform an authentication on the subscriber associated with the mobile device. The AUSF 110 may interact with the UDM 122 to determine whether the identity and credentials of the subscriber are authorized to access the wireless network. The AUSF 110 may also determine the appropriate security context for the subscriber based on the identity, subscription data, and authorization level. The NSSF 114 may interact with the NRF 118 and the AMF 108 to exchange information about network slice selection for the services requested by the UE 102. The PCF 120 may be configured to enable efficient policy control and management, facilitating network behavior control, network slice selection, UE activities, and communication with other network functions. The UDM 122 may be configured to manage the user data, where a range of disparate data sources are consolidated to create a single source of data stored within a data warehouse. The NEF 116 may act as a centralized point of service exposure, allowing wireless carriers to securely handle valuable data coming from the AF 124 and enabling optimal allocation and utilization of network resources. The AF 124 may be configured to manage application-related functionalities. Once the subscriber associated with the UE 102 is authenticated, a communication session may be established for the UE 102 to access the Internet 126 through the UPF 106.

In implementations, a network function may have multiple instances that have been deployed or changed. The NRF 118 may keep a profile of an available network function in the network, and update it when a new instance is deployed or changed. The profile may include information such as an NF type, a network address of an NF instance, capacity of the NF instance, supported NF services, authorization information, etc. In some examples, a first network function that uses services provided by a second network function may subscribe to the events that cause the status change of the second network function. The first network function may be referred to as an NF consumer, a service consumer, or a consumer. The second network function may be referred to as an NF producer, a service producer, or a producer. For examples, the AMF 108 (i.e., the service consumer) may send a discovery request to the NRF 118 to discover the available SMF instances (i.e., the service producers). Upon receiving a list of available SMF instances, the AMF 108 may select one SMF instance (e.g., the SMF 112) to provide services to the UE 102. In yet another example, the SMF 112 (i.e., the service consumer) may send a discovery request to the NRF 118 to discover the available UPF instances (i.e., the service producers). Upon receiving a list of available UPF instances, the SMF 112 may select one UPF instance (e.g., the UPF 106) to provide services to the UE 102.

In implementations, an NF consumer may subscribe to an NF producer to receive status update of the NF producer. The NRF 118 MAY notify the NF consumer about the status change of the NF producer, once receiving an update request from the NF producer. However, the NRF currently cannot notify the NF about its own status change or the change in NF registration on an ad-hoc basis. The NRF has to rely on an NF to handle the HTTP2 GOAWAY request and further rejection/no-responses message when it has to be taken out of range (OOR). Depending on the time of the detection of NRF OOR on the NF, unnecessary subscription failures may occur. Additionally, the NRF has to wait for a next NF update request to inform the NF about the change in a heartbeat timer pre-set for the NF. If the NF had initially communicated with the NRF in a high heartbeat timer, the NF may have to re-register with another NRF when the NRF is taken down, causing additional issues.

The present disclosure enables the NF to subscribe to the NRF to receive status change of the NRF. In some examples, when sending the subscription data, the NF may identify the NRF, of which, the status change is requested to be monitored. In implementations, the NF may designate the NRF in the “subscrCond” attribute of the subscription data. The NF may further designate one or more types of events in the “reqNotifEvents” attribute of the subscription data that the NF is interested in receiving notifications. The notifications generated based on the events may include but are not limited to, request to re-register, heartbeat timer change, availability time of the NRF, request to re-subscribe, etc. In some examples, the NF may subscribe to receive all events of the NRF. By subscribing to the NRF events, the network functions in the network can be promptly notified about any status change or the registration information change, therefore, alleviating unnecessary re-registration or re-subscription attempts from the network functions.

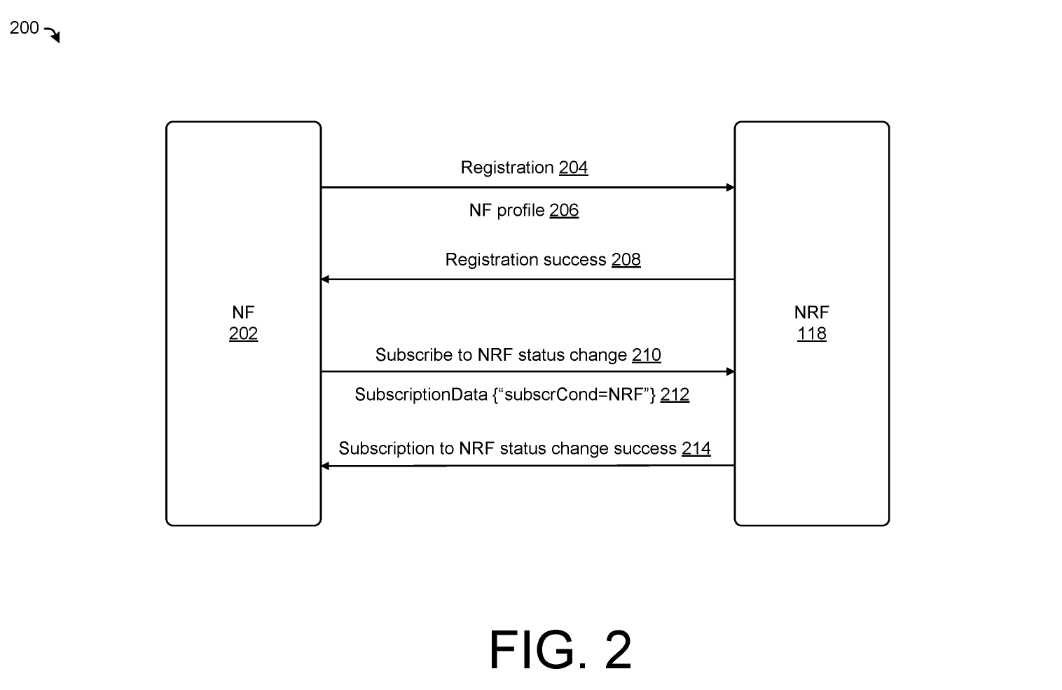

FIG. 2 illustrates an example scenario, in which, the NRF status notification is implemented according to an example of the present disclosure.

The example scenario 200 illustrates the communications between a network function (NF) 202 and the NRF 118. As shown, the NF 202 may send a registration request at operation 204 when it is newly added to the network. In implementations, deploying a new instance of the NF 202 in the network or updating an existing instance of the NF 202 may also trigger a registration request to the NRF 118. The NF 202 or the instance of the NF 202 may send an NF profile along with the registration request at operation 206. The NF profile may include information such as the type of the NF 202 (e.g., AMF, SMF, PCF, AUSF, etc.), a network address of the NF instance (e.g., IPv6 address), capacity of the NF instance (e.g., relative processing capacity of an AMF in relation to other AMFs in a pool), supported NF services (e.g., session management, discovery, slice selection, etc.), authorization information (e.g., NF instance ID), etc. The NRF 118 may send a registration success response to the NF 202 at operation 208.

In implementations, the NF 202 or the instance of the NF 202 may send a request to subscribe to NRF status change at operation 210. The request may include subscription data indicative of various attributes associated with the subscription. For example, the “subscrCond” attribute of the subscription data may be set as NRF at operation 212 to indicate the NRF or a set of the NRF instances whose status is requested to be monitored. In another example, the “validityTime” attribute of the subscription data may be set to indicate a time period, after which, the subscription to the NRF becomes invalid. The NRF 118 may send a response indicating a subscription to the NRF status change is successful at operation 214.

Although not shown, the NF 202 may also subscribe to other NFs by setting the “subscrCond” attribute to other NFs. For example, the NF 202 may designate a particular NF in the “subscrCond” attribute. Alternatively, when the “subscrCond” attribute is not present in the subscription data, it may indicate that the NF 202 requests to subscribe to all NFs in the NRF 118.

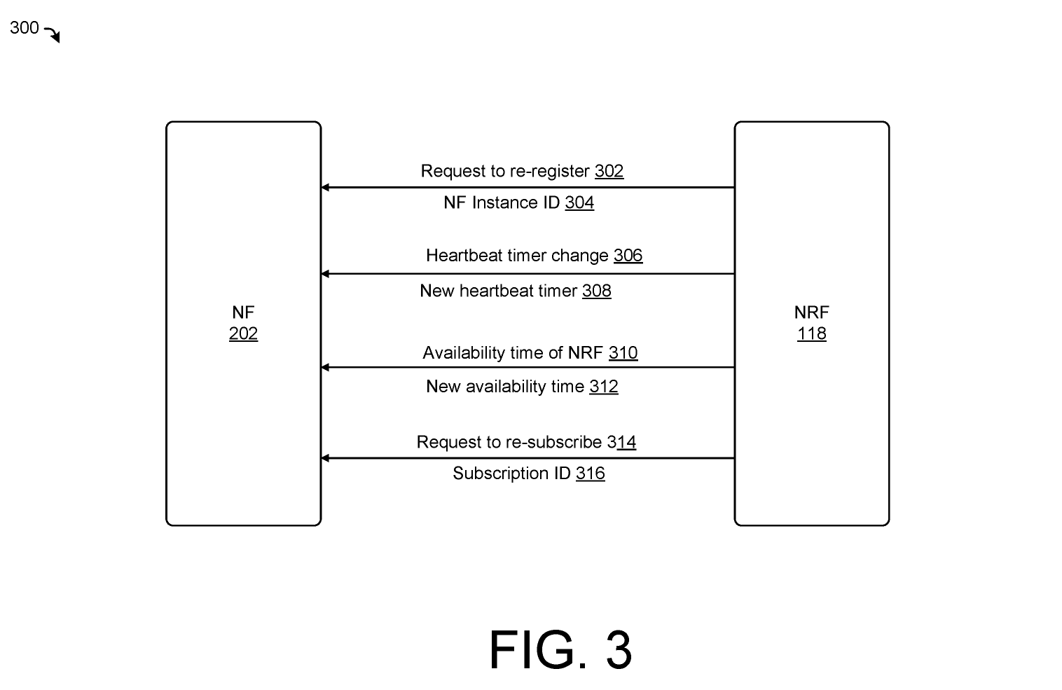

FIG. 3 illustrates an example scenario, in which, the NRF status notification is implemented according to another example of the present disclosure.

The example scenario 300 illustrates the communications between the NF 202 and the NRF 118 when the NRF status change is triggered. In some examples, the NRF status change may be triggered by a change of the registration information such as, missing the profile of the NF 202. The NRF 118 may send a request to re-register to the NF 202 at operation 302. In implementations, the NRF 118 may forward a pre-registered NF instance ID to the NF 202 at operation 304. In another examples, the NRF status change may be triggered by a change of the heartbeat timer used between between the NF 202 and the NRF 118. The NRF 118 may send a notification of the heartbeat timer change to the NF 202 at operation 306. The NRF 118 may additionally send the new heartbeat timer to the NF 202 at operation 308. In yet another example, the NRF status change may be triggered by an availability time of the NRF. The NRF 118 may send a notification of the availability time to the NF 202 at operation 310. The NRF 118 may also send the new availability time to the NF 202 at operation 312. In yet another example, the NRF status change may be triggered by an expiring subscription or a missing subscription. The NRF 118 may send a request to re-subscribe to the NF 202 at operation 314. The NRF 118 may also forward a previously set subscription ID to the NF 202 at operation 316.

It should be understood that the events triggering the NRF status change described herein are for the purpose of illustration. The present disclosure is not intended to be limiting. The NF 202 may subscribe to other events notification or all events notification from the NRF 118. The other events notification may include but is not limited to, the NF profile change, the registration of an NF instance being changed (e.g., added, revised, or deleted), the changes in the NRF instance (e.g., newly added NRF instance), etc.

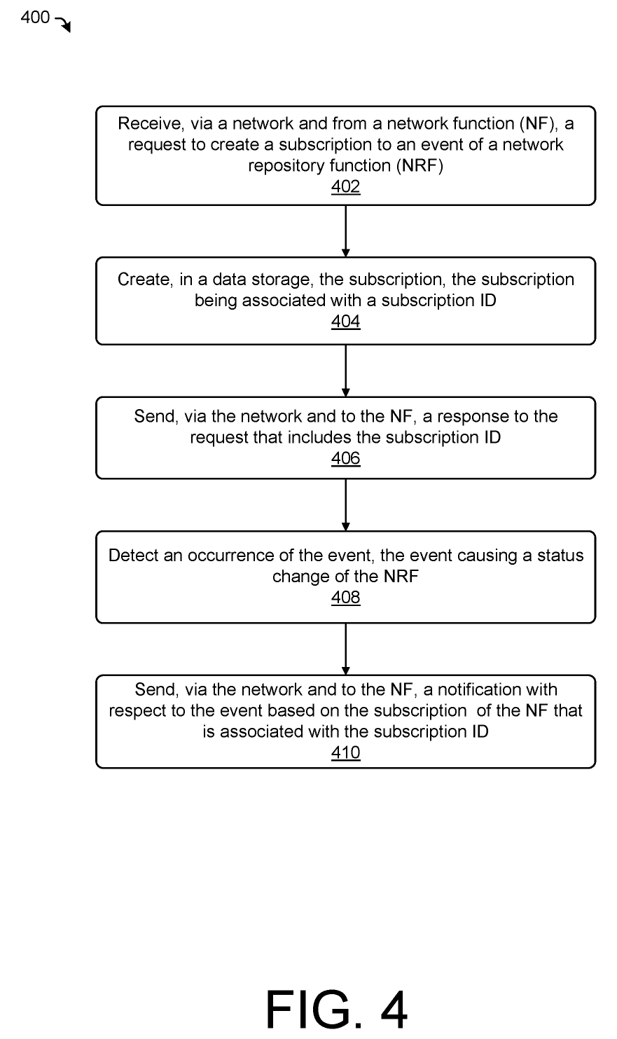

FIG. 4 illustrates an example process for notifying an NF regarding the status change of an NRF according to an example of the present disclosure. The example process 400 may be performed by a network repository function in a wireless communication network (e.g., NRF 118 in FIGS. 1-3).

At operation 402, the process may include receiving, via network and from a network function (NF), a request to create a subscription to an event of a network repository function (NRF). As discussed herein, the NF may configure a first attribute in the subscription data (e.g., the “subscrCond”) to identify the NRF, of which, the status is requested to be monitored. The NF may also configure a second attribute in the subscription data (e.g., “validityTime”) to indicate a time period, after which, the subscription becomes invalid. Additionally, the NF may configure a third attribute in the subscription data (“reqNotifEvents”) to indicate one or more types of event notifications. In implementations, the NF may subscribe to all events associated with the NRF or one or more particular events.

At operation 404, the process may include creating, in a data storage, the subscription, the subscription being associated with a subscription ID. As discussed herein, based on the subscription data sent by the NF, the NRF may generate a subscription record in the data storage and assign a subscription ID to be associated with the subscription.

At operation 406, the process may include sending, via the network and to the NF, a response to the request that includes the subscription ID. As discussed herein, the response may also indicate the success or completion of the subscription being created in the NRF data storage.

At operation 408, the process may include detecting an occurrence of the event, the event causing a status change of the NRF. In some examples, any changes in the NRF processing or any changes the data stored in the data storage of the NRF may trigger a status change. For example, a registered NF profile change or missing may trigger an event notification to the NF. In another example, an expired subscription, an expiring subscription, or a missing subscription may trigger an event notification to the NF. In yet another examples, adding a profile of a newly deployed NF instance or modifying/deleting an existing profile of a deployed NF instance may trigger an event notification to the NF. In yet another examples, deploying a new NRF instance or modifying/removing an existing NRF instance may trigger an event notification to the NF. In yet another example, the NRF may update a heartbeat timer used between the NF and the NRF, thus, triggering an event notification to the NF. In yet another example, the NRF may update its availability time, thus, triggering an event notification to the NF.

At operation 410, the process may include sending, via the network and to the NF, a notification with respect to the event based on the subscription of the NF that is associated with the subscription ID. As discussed herein, the notification may include but is not limited to, requesting to re-register, a request to update the heartbeat timer, a request to update the availability time of the NRF, the request to re-subscribe, etc.

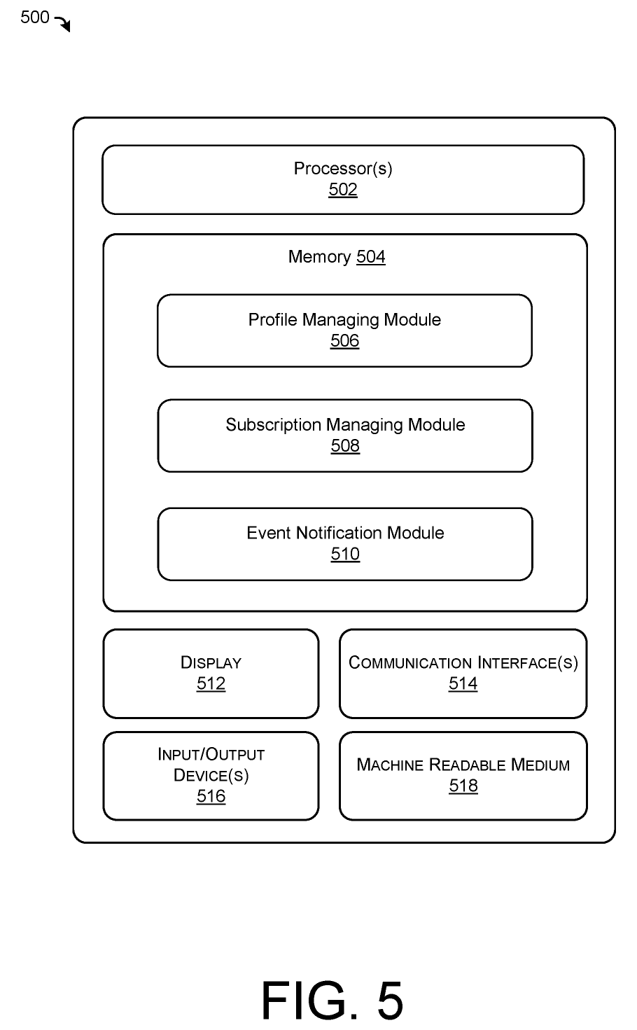

FIG. 5 illustrates an example computing device, in which methods for NRF status notification are implemented according to an example of the present disclosure. The example computing device 500 may correspond to a network repository function in a wireless communication network (e.g., NRF 118 in FIGS. 1-3).

As illustrated in FIG. 5, a computing device 500 may comprise processor(s) 502, a memory 504 storing a profile management module 506, a subscription management module 508, and an event notification module 510, a display 512, communication interface(s) 514, input/output device(s) 516, and/or a machine readable medium 518.

In various examples, the processor(s) 502 can be a central processing unit (CPU), a graphics processing unit (GPU), or both CPU and GPU, or any other type of processing unit. Each of the one or more processor(s) 502 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 502 may also be responsible for executing all computer applications stored in memory 504, which can be associated with common types of volatile (RAM) and/or nonvolatile (ROM) memory.

In various examples, the memory 504 can include system memory, which may be volatile (such as RAM), non-volatile (such as ROM, flash memory, etc.) or some combination of the two. The memory 504 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing device 800. Any such non-transitory computer-readable media may be part of the computing device 800.

The profile managing module 506 may be configured to create, modify, and manage the profiles of various network functions in the wireless communication network. The profile managing module 506 may periodically update the profiles stored therein based on the update report from these network functions. For example, the profile managing module 506 may update a profile of an NF to include information associated with a newly added NF instance. In another example, the profile managing module 506 may update the profile of the NF to modify or de-register an NF instance. In yet another examples, the profile managing module 506 may update a profile of an NF to reflect the up-to-date capacity of the NF.

The subscription managing module 508 may be configured to manage the subscriptions of the network functions. For example, the subscription managing module 508 may create a subscription for an NF to subscribe to an NRF. In another example, the subscription managing module 508 may create a subscription for an NF to subscribe to another NF. The subscription managing module 508 may share, with the NF, the profile of the NF or the NRF that the NF subscribes to. The subscription managing module 508 may periodically send an update to the NF about the updates on the subscribed NFs or NRF. In some examples, the subscription managing module 508 may proactively send an event notification to the subscribed NFs when the event causes a status change of the NRF.

The event notification module 510 may be configured to send the notification based on the detected events on the NRF. In some examples, the detected event is related to NF registration information being missing and the event notification module 510 may generate a request for the NF to re-register. In another example, the detected event is related to NF subscription is expiring and the event notification module 510 may generate a request for the NF to re-subscribe. In yet another example, the detected event is related to a change of the heartbeat timer previously set for the NF and the NRF and the event notification module 510 may generate a request for the NF to update the newly set heartbeat timer. In yet another example, the detected event is related to a change of the availability time of the NRF and the event notification module 510 may generate a request for the NF to update the availability time of the NRF.

The communication interface(s) 514 can include transceivers, modems, interfaces, antennas, and/or other components that perform or assist in exchanging radio frequency (RF) communications with base stations of the telecommunication network, a Wi-Fi access point, and/or otherwise implement connections with one or more networks. For example, the communication interface(s) 514 can be compatible with multiple radio access technologies, such as 5G radio access technologies and 4G/LTE radio access technologies. Accordingly, the communication interfaces 614 can allow the computing device 800 to connect to the 5G system described herein.

Display 512 can be a liquid crystal display or any other type of display commonly used in the computing device 800. For example, display 512 may be a touch-sensitive display screen and can then also act as an input device or keypad, such as for providing a soft-key keyboard, navigation buttons, or any other type of input. Input/output device(s) 516 can include any sort of output devices known in the art, such as display 512, speakers, a vibrating mechanism, and/or a tactile feedback mechanism. Input/output device(s) 516 can also include ports for one or more peripheral devices, such as headphones, peripheral speakers, and/or a peripheral display. Input/output device(s) 516 can include any sort of input devices known in the art. For example, input/output device(s) 516 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 518 can store one or more sets of instructions, such as software or firmware, which embodies any one or more of the methodologies or functions described herein. The instructions can also reside, completely or at least partially, within the memory 504, processor(s) 502, and/or communication interface(s) 514 during execution thereof by the computing device 800. The memory 504 and the processor(s) 502 also can constitute machine readable media 618.

The various techniques described herein may be implemented in the context of computer-executable instructions or software, such as program modules, which are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### Conclusion

Although the subject matter has been described in language specific to structural features and/or methodological acts, it is to be understood that the subject matter is not necessarily limited to the specific features or acts described above. Rather, the specific features and acts described above are disclosed as example examples.

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A network repository function (NRF), comprising:
a processor;
a non-transitory computer-readable memory storing computer-executable instructions that, when executed by the processor, cause the processor to perform actions including:
receiving, via a network and from a network function (NF), a request to create a subscription to an event of the NRF;
creating, in a data storage, the subscription, the subscription being associated with a subscription ID;
sending, via the network and to the NF, a response to the request that includes the subscription ID;
detecting an occurrence of the event, the event causing a status change of the NRF; and
sending, via the network and to the NF, a notification with respect to the event based on the subscription of the NF that is associated with the subscription ID.

2. The network repository function (NRF) of claim 1, wherein the request identifies the NRF, of which, the status change is requested to be monitored.

3. The network repository function (NRF) of claim 1, wherein the request includes subscription data, wherein attribute of SubscrCond in the subscription data is set as the NRF.

4. The network repository function (NRF) of claim 1, wherein the request identifies a validity time, after which, the subscription is invalid.

5. The network repository function (NRF) of claim 1, wherein
the event indicates a registration of the NF is expired or the registration of the NF is lost, and
the notification includes a request for the NF to re-register.

6. The network repository function (NRF) of claim 1, wherein
the event indicates a change of heartbeat timer pre-set for the NF, and
the notification includes a new heartbeat timer set for the NF.

7. The network repository function (NRF) of claim 1, wherein
the event indicates a change of an availability time of the NRF, and
the notification includes a new availability time of the NRF.

8. The network repository function (NRF) of claim 1, wherein
the event indicates the subscription is expired or the subscription is expiring after a time period, and
the notification includes a request for the NF to re-subscribe.

9. A computer-implemented method, comprising:
receiving, via a network and from a network function (NF), a request to create a subscription to an event of a network repository function (NRF);
creating, in a data storage, the subscription, the subscription being associated with a subscription ID;
sending, via the network and to the NF, a response to the request that includes the subscription ID;
detecting an occurrence of the event, the event causing a status change of the NRF; and
sending, via the network and to the NF, a notification with respect to the event based on the subscription of the NF that is associated with the subscription ID.

10. The computer-implemented method of claim 9, wherein the request identifies the NRF, of which, the status change is requested to be monitored.

11. The computer-implemented method of claim 9, wherein the request includes subscription data, wherein attribute of SubscrCond in the subscription data is set as the NRF.

12. The computer-implemented method of claim 9, wherein the request identifies a validity time, after which, the subscription is invalid.

13. The computer-implemented method of claim 9, wherein
the event indicates a registration of the NF is expired or the registration of the NF is lost, and
the notification includes a request for the NF to re-register.

14. The computer-implemented method of claim 9, wherein
the event indicates a change of heartbeat timer pre-set for the NF, and
the notification includes a new heartbeat timer set for the NF.

15. The computer-implemented method of claim 9, wherein
the event indicates a change of an availability time of the NRF, and
the notification includes a new availability time of the NRF.

16. The computer-implemented method of claim 9, wherein
the event indicates the subscription is expired or the subscription is expiring after a time period, and
the notification includes a request for the NF to re-subscribe.

17. A computer-readable storage medium storing computer-readable instructions, that when executed by a processor, cause the processor to perform operations comprising:
receiving, via a network and from a network function (NF), a request to create a subscription to an event of a network repository function (NRF);
creating, in a data storage, the subscription, the subscription being associated with a subscription ID;
sending, via the network and to the NF, a response to the request that includes the subscription ID;
detecting an occurrence of the event, the event causing a status change of the NRF; and
sending, via the network and to the NF, a notification with respect to the event based on the subscription of the NF that is associated with the subscription ID.

18. The computer-readable storage medium of claim 17, wherein the request includes subscription data, wherein attribute of SubscrCond in the subscription data is set as the NRF.

19. The computer-readable storage medium of claim 17, wherein
the event indicates a change of an availability time of the NRF, and
the notification includes a new availability time of the NRF.

20. The computer-readable storage medium of claim 17, wherein
the event indicates a change of heartbeat timer pre-set for the NF, and
the notification includes a new heartbeat timer set for the NF.
